(19) United States
(12) Patent Application Publication
(10) Pub. No.: US 2026/0227784 A1
(43) Pub. Date: Aug. 6, 2026

(54) METHOD, SYSTEM, AND NON-TRANSITORY COMPUTER-READABLE RECORDING MEDIUM FOR CONTROLLING A SERVING ROBOT

(71) Applicant: Bear Robotics, Inc., Redwood City, CA (US)

(72) Inventors: Louis Maurice PLOTTEL, Redwood City, CA (US); Marko Santoso WIJAYA, Redwood City, CA (US)

(73) Assignee: Bear Robotics, Inc., Redwood City, CA (US)

(21) Appl. No.: 19/150,232

(22) PCT Filed: Dec. 5, 2023
(86) PCT No.: PCT/US2023/082410

§ 371 Date: Jul. 23, 2025

Related U.S. Application Data
(60) Provisional application No. 63/445,347, filed on Feb. 14, 2023.

(51) Int. Cl. G05D 1/606; G05D 105/30; G05D 109/10; G05D 111/50

(52) U.S. Cl. CPC G05D 1/606; G05D 2105/31; G05D 2109/10; G05D 2111/50

(57) ABSTRACT

A method for controlling a serving robot is provided. The method includes the steps of: acquiring sensor data and order data on at least one object placed on at least one support coupled to the serving robot; specifying a serving object to be served from among the at least one object, with reference to the sensor data and the order data, and emitting light indicating a particular support on which the serving object is placed, from a part of a light emission unit of the serving robot that corresponds to the particular support; and dynamically adjusting the light emitted from the light emission unit on the basis of information on environment acquired during operation of the serving robot.

### CROSS-REFERENCE TO RELATED APPLICATION

This application claim the benefit of U.S. Provisional Application No. 63/445,347 filed on Feb. 14, 2023, the entire contents of which are herein incorporated by reference.

### FIELD OF THE INVENTION

The present invention relates to a method, system, and non-transitory computer-readable recording medium for controlling a serving robot.

### BACKGROUND

Serving means providing objects including drinks or food to customers in a place such as a restaurant. In recent years, robots and the like have been developed and used for serving in place of, or rendering assistance to, waiters or waitresses. Such a robot usually functions to take food orders or carry out serving according to the orders, and may perform autonomous navigation using table position information or the like. The robot may comprise a transport means (including sensors for avoiding obstacles), a display means for menu output or order input, and the like. Further, the robot may include a means for placing or carrying food or food containers.

As an example of related conventional techniques, Korean Registered Patent Publication No. 10-1083700 discloses a restaurant serving robot system for taking orders in a restaurant and transporting a tray where ordered food is placed, the system comprising: an upper part including a pair of articulated robot arms which are synchronously driven, and a tray holding part rotatably coupled to a lower end of the articulated robot arms and configured to fix the tray; a lower part at a bottom part of which a robot moving part including a main wheel and one or more auxiliary wheels is provided; a middle part fixed to the lower part and rotatably connected to the upper part; and a control part configured to control the operations of the pair of articulated robot arms, the tray holding part, and the robot moving part, wherein the tray holding part comprises: a hand rotatably coupled to an end of the articulated robot arms; a fixing part provided at the hand to move upward and downward; a gripper positioned at a bottom part of the tray and coupled to the fixing part; a stopper positioned at a top part of the tray and coupled to the fixing part to face the gripper; a switch pressed by the fixing part which moves upward when the stopper is pressed by the tray at the same time the end of the articulated robot arms is driven downward; a spring contracted when the fixing part moves upward; and a gripper angle detection unit configured to detect an angle of the gripper.

Meanwhile, although the techniques introduced so far have proposed various display means for visually displaying the operation status of a serving robot, they have a limitation in that they have failed to propose a means for intuitively displaying the operation status of the serving robot while simplifying electrical connections.

In this connection, the inventor(s) present a technique capable of intuitively and easily indicating the operation status of a serving robot by emitting light from a part of a light emission unit of the serving robot that corresponds to a location where a serving object is placed.

### SUMMARY OF THE INVENTION

One object of the present invention is to solve all the above-described problems in the prior art.

Another object of the invention is to intuitively and easily indicate the operation status of a serving robot, by acquiring sensor data and order data on at least one object placed on at least one support coupled to the serving robot; specifying a serving object to be served from among the at least one object, with reference to the sensor data and the order data, and emitting light indicating a particular support on which the serving object is placed, from a part of a light emission unit of the serving robot that corresponds to the particular support; and dynamically adjusting the light emitted from the light emission unit on the basis of information on environment acquired during operation of the serving robot.

Yet another object of the invention is to allow light emitted from a light emission unit of a serving robot to be highly visible throughout the front, side, and rear of the serving robot while simplifying electrical connections for the light emission unit of the serving robot, by causing the light emission unit disposed on a pillar of the serving robot to comprise an LED strip formed along a longitudinal direction of the pillar, a diffusing cover formed along the longitudinal direction of the pillar at a predetermined angle and a predetermined distance from the LED strip, and a channel formed along the longitudinal direction of the pillar such that the angle and distance between the LED strip and the diffusing cover are maintained.

The representative configurations of the invention to achieve the above objects are described below.

According to one aspect of the invention, there is provided a method for controlling a serving robot, comprising the steps of: acquiring sensor data and order data on at least one object placed on at least one support coupled to the serving robot; specifying a serving object to be served from among the at least one object, with reference to the sensor data and the order data, and emitting light indicating a particular support on which the serving object is placed, from a part of a light emission unit of the serving robot that corresponds to the particular support; and dynamically adjusting the light emitted from the light emission unit on the basis of information on environment acquired during operation of the serving robot.

According to another aspect of the invention, there is provided a system for controlling a serving robot, comprising: a data acquisition unit configured to acquire sensor data and order data on at least one object placed on at least one support coupled to the serving robot; and a display status management unit configured to specify a serving object to be served from among the at least one object, with reference to the sensor data and the order data, emit light indicating a particular support on which the serving object is placed, from a part of a light emission unit of the serving robot that corresponds to the particular support, and dynamically adjust the light emitted from the light emission unit on the basis of information on environment acquired during operation of the serving robot.

In addition, there are further provided other methods and systems to implement the invention, as well as non-transitory computer-readable recording media having stored thereon computer programs for executing the methods.

According to the invention, it is possible to implement a serving robot capable of easily indicating a location of a serving object mounted in the serving robot, and intuitively displaying the operation status of the serving robot, while simplifying electrical connections compared to a conventional serving robot that needs to include a separate light emission means for each support (or tray).

According to the invention, it is possible to allow light emitted from a light emission unit of a serving robot to be highly visible throughout the front, side, and rear of the serving robot.

### BRIEF DESCRIPTION OF THE DRAWINGS

FIG. 1 schematically shows the configuration of an entire system for controlling a serving robot according to one embodiment of the invention.

FIG. 2 specifically shows the internal configuration of a robot control system according to one embodiment of the invention.

FIG. 3 illustratively shows the configuration of a serving robot according to one embodiment of the invention.

FIG. 4 illustratively shows a situation in which light is emitted from a light emission unit of a serving robot according to one embodiment of the invention.

FIG. 5 illustratively shows a situation in which light is emitted from a light emission unit of a serving robot according to one embodiment of the invention.

FIGS. 6A and 6B illustratively shows the configuration of a light emission unit according to one embodiment of the invention.

FIG. 7 illustratively shows the configuration of a light emission unit according to one embodiment of the invention.

FIGS. 8A and 8B illustratively shows the configuration of a light emission unit according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the Entire System

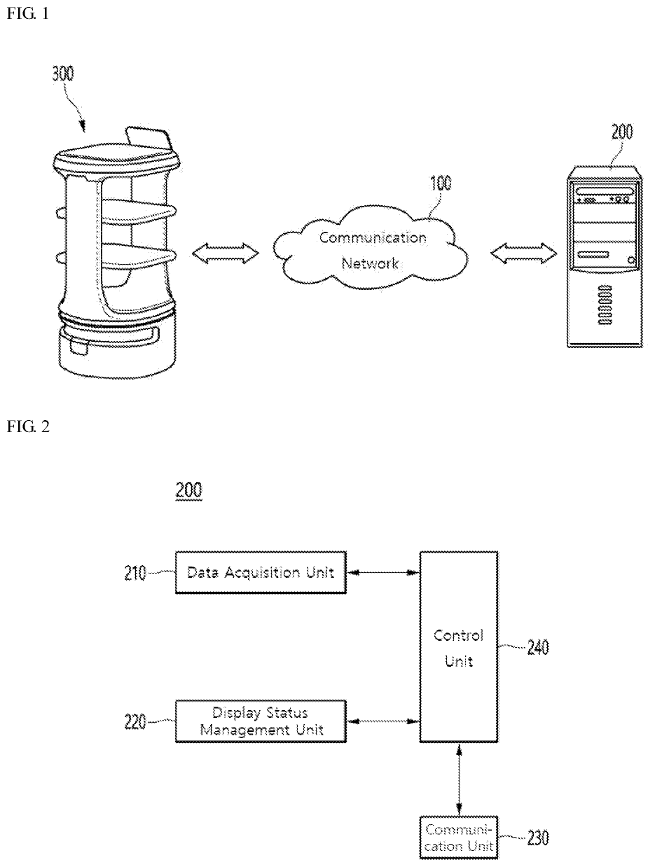

FIG. 1 schematically shows the configuration of the entire system for controlling a serving robot according to one embodiment of the invention.

As shown in FIG. 1, the entire system according to one embodiment of the invention may comprise a communication network 100, a robot control system 200, and a serving robot 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as Wi-Fi communication, Wi-Fi Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the robot control system 200 according to one embodiment of the invention may function to: acquire sensor data and order data on at least one object placed on at least one support coupled to the serving robot; specify a serving object to be served from among the at least one object, with reference to the sensor data and the order data, and emit light indicating a particular support on which the serving object is placed, from a part of a light emission unit of the serving robot that corresponds to the particular support; and dynamically adjust the light emitted from the light emission unit on the basis of information on environment acquired during operation of the serving robot.

The configuration and functions of the robot control system 200 according to the invention will be discussed in more detail below.

Next, the serving robot 300 according to one embodiment of the invention is a device capable of communicating with the robot control system 200 via the communication network 100 and performing predetermined functions or assigned tasks (e.g., serving food or retrieving containers) autonomously without any manipulation of a user (e.g., an employee or a customer), and may include a support configured to support at least one object. Further, the serving robot 300 according to one embodiment of the invention may include at least one of a module (e.g., a grab or a robotic arm module) for loading and unloading an object (e.g., a food tray), an imaging module (e.g., a visible light camera or an infrared camera) for acquiring images of surroundings, a scanner module (e.g., a LIDAR sensor) for acquiring information on obstacles, a sound acquisition module (e.g., a microphone) for acquiring sounds of surroundings, a display and speaker module for providing images or sounds, and a drive module (e.g., a motor) for moving the serving robot 300.

For example, the serving robot 300 may have characteristics or functions similar to those of at least one of a guide robot, a transport robot, a cleaning robot, a medical robot, an entertainment robot, a pet robot, and an unmanned flying robot. Meanwhile, supporting of an object herein should be interpreted as encompassing supporting of a container for containing an object such as food, a means where the container may be placed (e.g., a tray), or the like.

Meanwhile, according to one embodiment of the invention, the serving robot 300 may include an application (not shown) for controlling the serving robot 300 according to the invention. The application may be downloaded from the robot control system 200 or an external application distribution server (not shown). According to one embodiment of the invention, the characteristics of the application may be generally similar to those of a data acquisition unit 210, a display status management unit 220, a communication unit 230, and a control unit 240 of the robot control system 200 to be described below. Here, at least a part of the application may be replaced with a hardware device or a firmware device that may perform a substantially equal or equivalent function, as necessary.

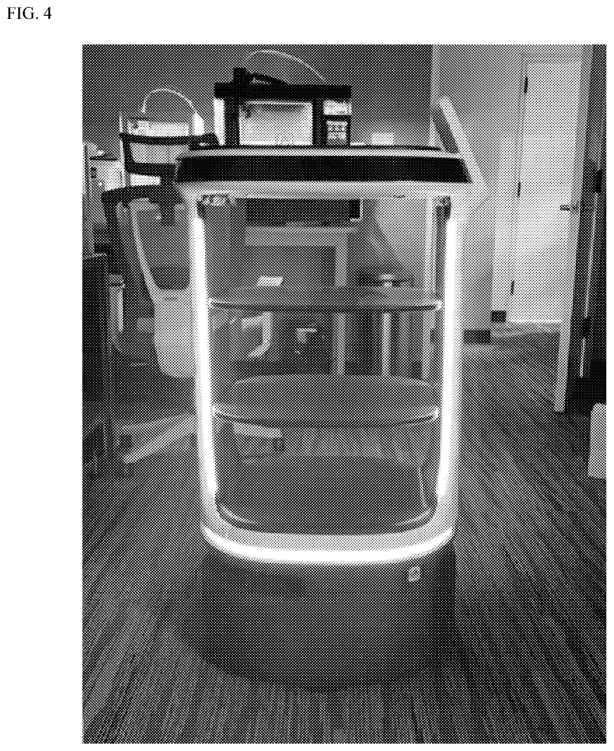

FIGS. 3 and 4 illustratively show the configuration of the serving robot 300 according to one embodiment of the invention.

Referring to FIG. 3, the serving robot 300 may comprise a main body 310, a drive unit 320, a processor (not shown), and a light emission unit 340.

First, the main body 310 according to one embodiment of the invention may be coupled to supports 310a, 310b, and 310c configured to support at least one object. According to one embodiment of the invention, the supports 310a, 310b, and 310c may be removably coupled for cleaning, replacement, or the like. Further, each of the supports 310a, 310b, and 310c may include a weight sensor (not shown) for sensing a weight supported by each of the supports 310a, 310b, and 310c. According to one embodiment of the invention, the weight sensor may be implemented using one or more strain gauges (e.g., three strain gauges or four strain gauges). In addition, according to one embodiment of the invention, the weight sensor may interwork with the processor.

Further, the main body 310 according to one embodiment of the invention may include an image sensor (not shown) configured to photograph a spatial region above each of the supports 310a, 310b, and 310c, in place of or in addition to the weight sensor. Meanwhile, according to one embodiment of the invention, the image sensors configured to photograph the spatial regions above the respective supports 310a, 310b, and 310c are not necessarily included in the main body 310, and at least some of the image sensors may be installed on a structure in a serving place.

Meanwhile, the main body 310 according to one embodiment of the invention may include at least one loading space for loading an object. Further, according to one embodiment of the invention, the at least one loading space may include the supports 310a, 310b, and 310c. The object according to one embodiment of the invention may refer to all material objects that can be moved by the serving robot 300, and may encompass things, animals, and the like. For example, the object according to one embodiment of the invention may include an object to be served such as food and an object to be bussed such as a container containing the food.

Referring further to FIG. 3, the drive unit 320 according to one embodiment of the invention may comprise a module for moving the main body 310 to other locations. For example, the drive unit 320 may include a module related to electrically, mechanically, or hydraulically driven wheels, propellers, or the like as the module for moving the main body 310 to other locations.

Next, the processor according to one embodiment of the invention may be electrically connected to the drive unit 320 to perform a function of controlling the drive unit 320 (and may include a communication module for communicating with an external system). For example, the processor may be a data processing device that are embedded in hardware and have circuits physically structured to perform codes included in a program or functions represented by instructions. For example, such a data processing device embedded in hardware may include a processing device such as a microprocessor, a central processing unit, a processor core, a multiprocessor, an application-specific integrated circuit (ASIC), and a field programmable gate array (FPGA).

Further, the processor may perform the functions of at least one of a data acquisition unit 210 and a display status management unit 220 of the robot control system 200 according to the invention (e.g., the corresponding functions may be modularized and included in the processor), and may function to control the drive unit 320 through communication with an external system (not shown) that performs the functions of at least one of the data acquisition unit 210 and the display status management unit 220.

Specifically, the processor may acquire sensor data and order data on at least one object placed on at least one support coupled to the serving robot; specify a serving object to be served from among the at least one object, with reference to the sensor data and the order data; emit light indicating a particular support on which the serving object is placed, from a part of a light emission unit of the serving robot that corresponds to the particular support; and dynamically adjust the light emitted from the light emission unit on the basis of information on environment acquired during operation of the serving robot.

Referring further to FIG. 3, the serving robot 300 according to one embodiment of the invention may include a light emission unit 340 that may be disposed on a pillar of the main body 310 along a longitudinal direction of the pillar. According to one embodiment of the invention, the light emission unit 340 may be formed to be long enough in a vertical direction to cover a section where at least the supports 310a, 310b and 310c mounted in the main body 310 of the serving robot 300 are disposed.

Further, according to one embodiment of the invention, the light emission unit 340 may also be disposed at a lower part of the main body 310 of the serving robot 300.

Meanwhile, according to one embodiment of the invention, the display status of the light emission unit 340 may be adjusted by the display status management unit 220 to be described below, and light may be emitted from all or part of the light emission unit 340 depending on how serving objects are mounted or the surrounding environment. The configuration for adjusting the display status of the light emission unit 340 will be described in detail below.

According to one embodiment of the invention, the light emission unit 340 may comprise an LED strip, a diffusing cover, and a channel. The configuration of the light emission unit 340 will be described in detail below.

### Configuration of the Robot Control System

Hereinafter, the internal configuration of the robot control system 200 crucial for implementing the invention and the functions of the respective components thereof will be discussed.

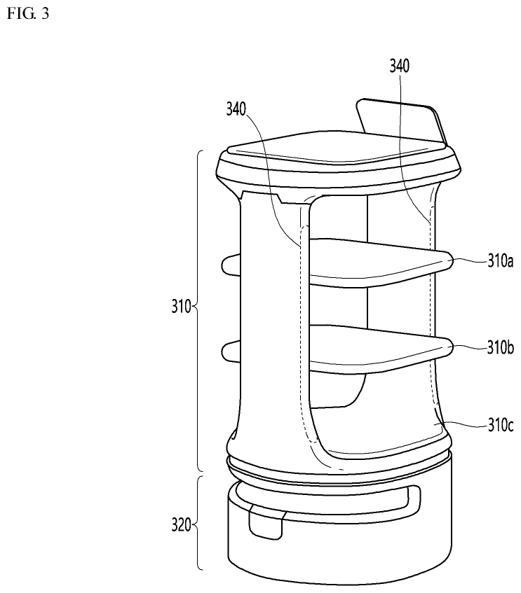

FIG. 2 specifically shows the internal configuration of the robot control system 200 according to one embodiment of the invention.

As shown in FIG. 2, the robot control system 200 according to one embodiment of the invention may comprise a data acquisition unit 210, a display status management unit 220, a communication unit 230, and a control unit 240. According to one embodiment of the invention, at least some of the data acquisition unit 210, the display status management unit 220, the communication unit 230, and the control unit 240 may be program modules that communicate with an external system (not shown). The program modules may be included in the robot control system 200 in the form of operating systems, application program modules, and other program modules, while they may be physically stored in a variety of commonly known storage devices. Further, the program modules may also be stored in a remote storage device that may communicate with the robot control system 200. Meanwhile, such program modules may include, but are not limited to, routines, subroutines, programs, objects, components, and data structures for performing specific tasks or executing specific abstract data types according to the invention as will be described below.

Meanwhile, the above description is illustrative although the robot control system 200 has been described as above, and it will be apparent to those skilled in the art that at least a part of the components or functions of the robot control system 200 may be implemented or included in the serving robot 300 or an external system (not shown), as necessary. Further, in some cases, all of the functions and components of the robot control system 200 may be implemented or included in the serving robot 300.

First, the data acquisition unit 210 according to one embodiment of the invention may acquire sensor data and order data on at least one object placed on at least one serving robot 300.

Specifically, a support may be coupled to the serving robot 300 according to one embodiment of the invention, and at least one object (e.g., an object to be served or an object to be bussed) may be placed on the support. Further, at least one first sensor (not shown) for acquiring first sensor data on the at least one object may be coupled to the serving robot 300 according to one embodiment of the invention.

More specifically, the sensor data acquired by the data acquisition unit 210 according to one embodiment of the invention using the first sensor may include sensor data for recognizing (or detecting) at least one object placed on the support. According to one embodiment of the invention, the object refers to an object transported by the serving robot 300 to be provided to a customer, and should be understood as encompassing an object retrieved by the serving robot 300 from the customer for washing or the like. Further, the object mostly refers to food but does not exclude dinnerware or other tools for eating.

For example, as described above, the sensor data according to one embodiment of the invention may include image data acquired from an image sensor with respect to at least one object placed on the support. That is, the data acquisition unit 210 according to one embodiment of the invention may acquire an image photographed by an image sensor configured to photograph a spatial region above the support, or a change in the image, as the sensor data on the at least one object placed on the support.

As another example, the sensor data may include data on a weight sensed by a weight sensor included in the support, or a change in the weight.

As another example, the data acquisition unit 210 according to one embodiment of the invention may decide whether at least one object is placed on the support on the basis of the weight data, and then when at least one object is placed on the support, the image sensor may acquire image data on the at least one object as the sensor data.

However, the sensor data on at least one object placed on the support coupled to the serving robot 300 is not limited to the foregoing, and may be diversely changed as long as the objects of the invention may be achieved. Further, according to one embodiment of the invention, it should be understood that the sensor data may be acquired for each of the at least one object placed on the support.

Further, the data acquisition unit 210 according to one embodiment of the invention may further acquire order data on orders to be processed by the serving robot.

Specifically, according to one embodiment of the invention, the order data may include data on which food (or serving object) is to be provided to which customer (or table), or data on which plate (or bussing object) is to be retrieved from which customer (or table). Further, according to one embodiment of the invention, the order data may include data on which serving object or bussing object is placed on which support of the serving robot 300.

Next, the display status management unit 220 according to one embodiment of the invention may specify a serving object to be served from among at least one object mounted in the serving robot 300, with reference to the sensor data and the order data.

For example, when the sensor data according to one embodiment of the invention includes image data on at least one object placed on the support, the display status management unit 220 according to one embodiment of the invention may process the image data on the at least one object using a machine learning-based object recognition model for objects that may be placed on the support, thereby deciding whether the at least one object is a serving object and specifically recognizing what the at least one object is. Here, according to one embodiment of the invention, the object recognition model may be implemented using an algorithm such as R-CNN (Region-based Convolutional Neural Network), YOLO (You Only Look Once), and SSD (Single Shot Detector). However, the object recognition model is not necessarily limited to the foregoing and may be diversely changed as long as the objects of the invention may be achieved.

As another example, when the sensor data according to one embodiment of the invention includes weight data on at least one object placed on the support, the display status management unit 220 according to one embodiment of the invention may compare and analyze data on the weight or a change in the weight and the weight of an object (or food) to be ordered, thereby specifically recognizing which object is placed on which support and deciding whether an object placed on a particular support is a serving object to be served.

Further, the display status management unit 220 according to one embodiment of the invention may emit light indicating (or highlighting) a particular support on which the serving object is placed, from a part of the light emission unit 340 disposed on the pillar of the main body 310 of the serving robot 300 that corresponds to the particular support.

FIGS. 4 and 5 illustratively show a situation in which information on a location of a serving object is visually (or intuitively) shown as light is emitted from a light emission unit of a serving robot according to one embodiment of the invention.

Referring to FIG. 4, the display status management unit 220 according to one embodiment of the invention may adjust the display status of the light emission unit 340 so that light is emitted from all of the light emission unit 340 disposed on a pillar and a lower part of the main body 310 of the serving robot 300.

Referring to FIG. 5, the display status management unit 220 according to one embodiment of the invention may adjust the display status of the light emission unit 340 so that light is emitted only from a part of the pillar of the main body 310 of the serving robot 300 that corresponds to a particular support on which a serving object is placed (or a middle support among three supports).

Further, the display status management unit 220 according to one embodiment of the invention may dynamically adjust the light emitted from the light emission unit 340 on the basis of information on environment acquired during operation of the serving robot 300.

For example, the display status management unit 220 according to one embodiment of the invention may specify a first serving object to be provided to a first customer (or a first table) with reference to the sensor data and the order data, and emit light indicating a first support on which the first serving object is placed, from a part of the light emission unit 340 disposed on the pillar of the serving robot 300 that corresponds to the first support, in response to the serving robot 300 being positioned in the vicinity of the first customer (or the first table). Thus, the first customer may intuitively and easily locate the support on which the first serving object for the first customer is placed, among the multiple supports mounted in the serving robot 300.

As another example, in response to a weight of an object placed on a first support among the at least one support mounted in the serving robot 300 exceeding a reference weight, the display status management unit 220 according to one embodiment of the invention may emit light indicating the first support from a part of the light emission unit 340 disposed on the pillar of the serving robot 300 that corresponds to the first support. Here, according to one embodiment of the invention, a pattern of light indicating overweight may be set differently from a pattern of light indicating a serving object. Thus, a manager or customer may intuitively and easily recognize a situation in which a heavy object exceeding a reference weight is placed on a support of the serving robot 300, and the manager or customer may reduce the weight of the object placed on the support of the serving robot 300 so that the serving robot 300 may operate in a state in which an object of a moderate weight is mounted.

As another example, in response to a temperature of an object placed on a first support among the at least one support mounted in the serving robot 300 exceeding a reference temperature, the display status management unit 220 according to one embodiment of the invention may emit light indicating (or highlighting) the first support from a part of the light emission unit 340 disposed on the pillar of the serving robot 300 that corresponds to the first support. Here, according to one embodiment of the invention, a pattern of light indicating overtemperature may be set differently from a pattern of light indicating a serving object or overweight. Thus, a manager or customer may intuitively recognize a situation in which a hot object exceeding a reference temperature is placed on a support of the serving robot 300, and the manager or customer may safely use the serving robot 300 while being mindful of the support on which the hot object is placed.

As another example, in response to the serving robot 300 being in a state of moving or rotating, or in a state of not being able to move or rotate (i.e., stuck), the display status management unit 220 according to one embodiment of the invention may emit light indicating the state of the serving robot 300 from the light emission unit 340 disposed on the pillar or lower part of the serving robot 300. Here, according to one embodiment of the invention, a pattern of light indicating abnormal movement or rotation may be set differently from a pattern of light indicating a serving object, overweight, or overtemperature. Thus, a manager or customer may visually and intuitively recognize information on whether the serving robot 300 is moving or rotating normally.

As another example, in response to the serving robot 300 being in a charging state, the display status management unit 220 according to one embodiment of the invention may emit light indicating the charging state of the serving robot 300 from the light emission unit 340 disposed on the pillar or lower part of the serving robot 300. Here, according to one embodiment of the invention, a pattern of light indicating a charging state may be set differently from a pattern of light indicating a serving object, overweight, overtemperature, or abnormal movement or rotation.

Next, the communication unit 230 according to one embodiment of the invention may function to enable data transmission/reception from/to the data acquisition unit 210 and the display status management unit 220.

Lastly, the control unit 240 according to one embodiment of the invention may function to control data flow among the data acquisition unit 210, the display status management unit 220, and the communication unit 230. That is, the control unit 240 according to one embodiment of the invention may control data flow into/out of the robot control system 200 or data flow among the respective components of the robot control system 200, such that the data acquisition unit 210, the display status management unit 220, and the communication unit 230 may carry out their particular functions, respectively.

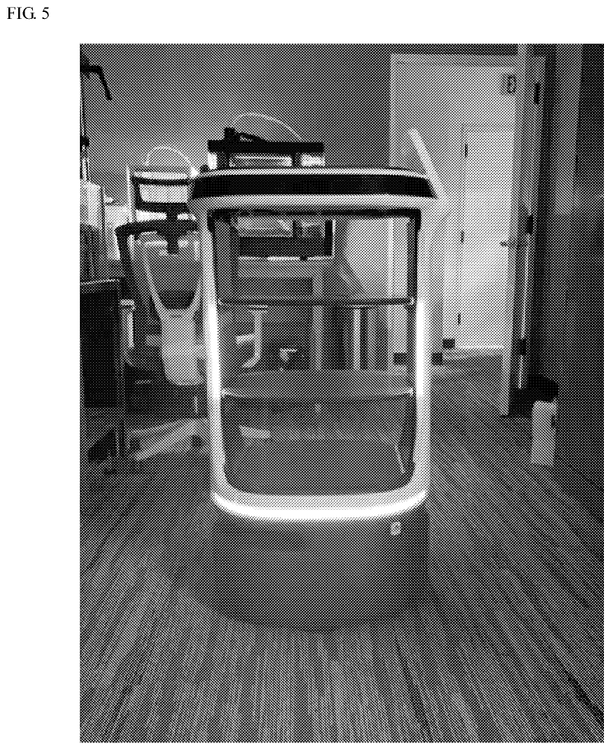

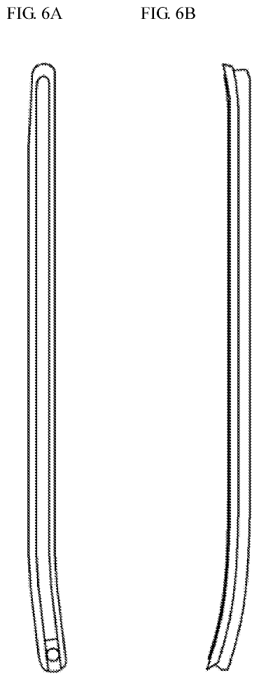

Meanwhile, FIGS. 6A to 8B illustratively show the configuration of a light emission unit according to one embodiment of the invention.

According to one embodiment of the invention, the light emission unit 340 disposed on the pillar of the main body 310 of the serving robot 300 may comprise an LED strip 341, a diffusing cover 342, and a channel 343.

First, the LED strip 341 according to one embodiment of the invention may be formed to be long enough to cover a section where the at least one support is disposed along the longitudinal direction of the pillar of the serving robot 300, and may include a plurality of LEDs disposed at a predetermined density over the entire section. For example, the plurality of LEDs may be included in the LED strip 341 at a density of 60 per meter, and the light emission status of the plurality of LEDs disposed as above may be individually controlled.

Next, the diffusing cover 342 according to one embodiment of the invention may be formed along the longitudinal direction of the pillar of the serving robot 300 at a predetermined angle and a predetermined distance from the LED strip 341, and may be formed to be long enough to cover all of the LED strip 341.

Next, the channel 343 according to one embodiment of the invention may be formed along the longitudinal direction of the pillar of the serving robot 300 as coupled to the LED strip 341 and the diffusing cover 342, and may be formed to be long enough to cover both the LED strip 341 and the diffusing cover 342. Further, the channel 343 according to one embodiment of the invention may fix a positional relationship between the LED strip 341 and the diffusing cover 342, thereby maintaining a state in which the LED strip 341 and the diffusing cover 342 are disposed at a predetermined angle and a predetermined distance from each other.

FIGS. 6A and 6B show side views of the light emission unit 340 disposed along the longitudinal direction of the pillar of the serving robot 300 according to one embodiment of the invention.

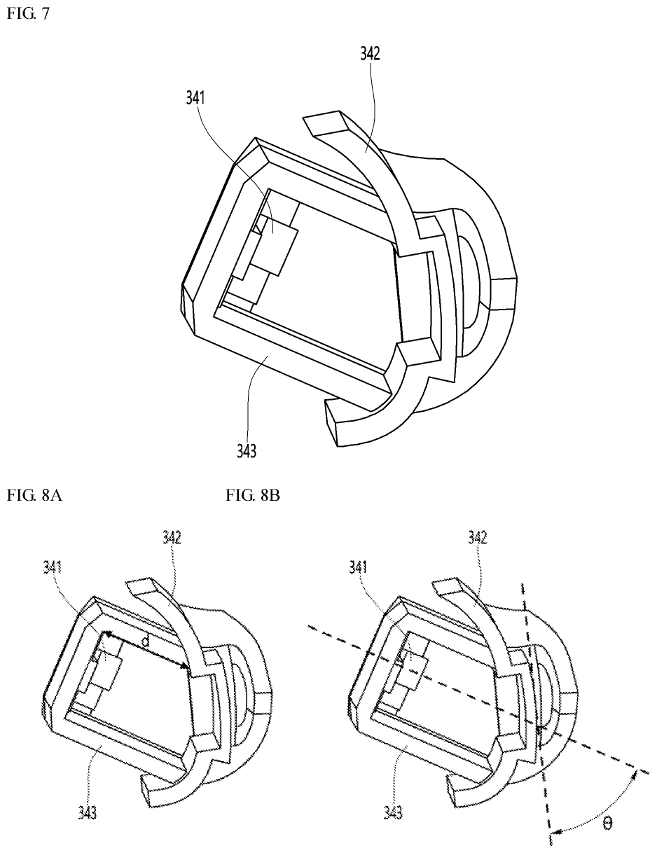

FIGS. 7 to 8B show cross-sectional views of the light emission unit 340 according to one embodiment of the invention. According to one embodiment of the invention, it can be seen that the channel 343 fixes a positional relationship between the LED strip 341 and the diffusing cover 342 such that the LED strip 341 and the diffusing cover 342 are disposed at a predetermined distance d and a predetermined angle θ.

Specifically, according to one embodiment of the invention, the distance d between the LED strip 341 and the diffusing cover 342 may allow light emitted from the LED strip 341 to be continuously and naturally shown to the outside through the diffusing cover 342. When the distance d between the LED strip 341 and the diffusing cover 342 is too short, the light emitted from the LED strip 341 may not be sufficiently diffused by the diffusing cover 342, resulting in a hot spot problem. The channel 343 according to one embodiment of the invention may function to prevent this problem by ensuring that the distance d between the LED strip 341 and the diffusing cover 342 is maintained at a predetermined level.

Further, according to one embodiment of the invention, the angle θ formed by the LED strip 341 and the diffusing cover 342 may be determined on the basis of a direction of travel of the light emitted from the LED strip 341 and a curvature of the diffusing cover 342, such that the light emitted from the LED strip 341 and passed through the diffusing cover 342 may be highly visible throughout the front, side, and rear of the serving robot 300. For example, the angle θ formed by the LED strip 341 and the diffusing cover 342 may refer to an angle formed by an imaginary line perpendicular to the LED strip 341 and an imaginary line parallel to an exterior face of the diffusing cover 342.

However, the configuration of the light emission unit 340 disposed along the longitudinal direction of the pillar of the serving robot 300 according to one embodiment of the invention is not limited to the foregoing, and may be diversely changed as long as the objects of the invention may be achieved.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for controlling a serving robot, comprising the steps of:
acquiring sensor data and order data on at least one object placed on at least one support coupled to the serving robot;
specifying a serving object to be served from among the at least one object, with reference to the sensor data and the order data, and emitting light indicating a particular support on which the serving object is placed, from a part of a light emission unit of the serving robot that corresponds to the particular support; and
dynamically adjusting the light emitted from the light emission unit on the basis of information on environment acquired during operation of the serving robot.

2. The method of claim 1, wherein the light emission unit is disposed on a pillar of the serving robot and comprises:
an LED strip formed along a longitudinal direction of the pillar;
a diffusing cover formed along the longitudinal direction of the pillar at a predetermined angle and a predetermined distance from the LED strip; and
a channel formed along the longitudinal direction of the pillar as coupled to the LED strip and the diffusing cover, such that the predetermined angle and the predetermined distance are maintained.

3. The method of claim 1, wherein in response to the serving robot in which a first object to be provided to a first customer is mounted being positioned in the vicinity of the first customer, light indicating a first support on which the first object is placed is emitted from a part of the light emission unit disposed on a pillar of the serving robot that corresponds to the first support.

4. The method of claim 1, wherein in response to a weight of an object placed on a first support among the at least one support exceeding a reference weight, light indicating the first support is emitted from a part of the light emission unit disposed on a pillar of the serving robot that corresponds to the first support.

5. The method of claim 1, wherein in response to a temperature of an object placed on a first support among the at least one support exceeding a reference temperature, light indicating the first support is emitted from a part of the light emission unit disposed on a pillar of the serving robot that corresponds to the first support.

6. The method of claim 1, wherein in response to the serving robot being in a state of moving or rotating, or in a state of not being able to move or rotate, light indicating the state of the serving robot is emitted from the light emission unit disposed on a pillar or a lower part of the serving robot.

7. The method of claim 1, wherein in response to the serving robot being in a charging state, light indicating the charging state of the serving robot is emitted from the light emission unit disposed on a pillar or a lower part of the serving robot.

8. A non-transitory computer-readable recording medium having stored thereon a computer program for executing the method of claim 1.

9. A system for controlling a serving robot, comprising:
a data acquisition unit configured to acquire sensor data and order data on at least one object placed on at least one support coupled to the serving robot; and
a display status management unit configured to specify a serving object to be served from among the at least one object, with reference to the sensor data and the order data, emit light indicating a particular support on which the serving object is placed, from a part of a light emission unit of the serving robot that corresponds to the particular support, and dynamically adjust the light emitted from the light emission unit on the basis of information on environment acquired during operation of the serving robot.

10. The system of claim 9, wherein the light emission unit is disposed on a pillar of the serving robot and comprises:
an LED strip formed along a longitudinal direction of the pillar;
a diffusing cover formed along the longitudinal direction of the pillar at a predetermined angle and a predetermined distance from the LED strip; and
a channel formed along the longitudinal direction of the pillar as coupled to the LED strip and the diffusing cover, such that the predetermined angle and the predetermined distance are maintained.

11. The system of claim 9, wherein in response to the serving robot in which a first object to be provided to a first customer is mounted being positioned in the vicinity of the first customer, light indicating a first support on which the first object is placed is emitted from a part of the light emission unit disposed on a pillar of the serving robot that corresponds to the first support.

12. The system of claim 9, wherein in response to a weight of an object placed on a first support among the at least one support exceeding a reference weight, light indicating the first support is emitted from a part of the light emission unit disposed on a pillar of the serving robot that corresponds to the first support.

13. The system of claim 9, wherein in response to a temperature of an object placed on a first support among the at least one support exceeding a reference temperature, light indicating the first support is emitted from a part of the light emission unit disposed on a pillar of the serving robot that corresponds to the first support.

14. The system of claim 9, wherein in response to the serving robot being in a state of moving or rotating, or in a state of not being able to move or rotate, light indicating the state of the serving robot is emitted from the light emission unit disposed on a pillar or a lower part of the serving robot.

15. The system of claim 9, wherein in response to the serving robot being in a charging state, light indicating the charging state of the serving robot is emitted from the light emission unit disposed on a pillar or a lower part of the serving robot.
